(19) United States
(12) Patent Application Publication
(10) Pub. No.: US 2019/0095296 A1
(43) Pub. Date: Mar. 28, 2019

(54) Reading or Reconstructing Requested Data from RAID Volume

(71) Applicant: HEWLETT PACKARD ENTERPRISE DEVELOPMENT LP, Houston, TX (US)

(72) Inventors: Thomas Duncan McMURCHIE, Belllevue, WA (US); Ming SU, Bellevue, WA (US); James Reid COOK, Bellevue, WA (US)

(21) Appl. No.: 15/717,834

(22) Filed: Sep. 27, 2017

(51) Int. Cl. G06F 11/20

(52) U.S. Cl. CPC G06F 11/2094; G06F 2201/82; G06F 2201/805

(57) ABSTRACT

An example data storage system includes a number of storage devices, and processing circuitry. The processing circuit may implement a redundant array of independent disks (RAID) volume using the storage devices, determine an estimated read wait time for each of the storage devices, sort the estimated read wait times into bins of a specified set of bins, and associate bin numbers with the storage devices based on the bins of their respective estimated read wait times. The processing circuitry may also, in response to a read request directed to the RAID volume, determine whether to read requested data specified in the read request from a target storage device, which is one of the storage devices that stores the requested data, or reconstruct the requested data from data stored in non-target storage devices of the storage devices, based on how many of the bin numbers of the non-target storage devices are greater than or greater-than-or-equal-to the difference between a bin number of the target storage device and a specified threshold.

### BACKGROUND

Data storage devices, such as hard disk and flash drives, are susceptible to various failures that may result in loss of data stored thereon. Accordingly, various techniques may be employed to protect important data from being permanently lost when a data storage device fails.

### BRIEF DESCRIPTION OF THE DRAWINGS

FIG. 1 illustrates an example storage system that includes an example RAID controller.

FIG. 2A illustrates example estimated read wait times sorted into an example set of bins.

FIG. 2B illustrates an example assignment of bin numbers to storage devices based on the example estimated read wait times of FIG. 2A.

FIG. 2C illustrates another example assignment of bin numbers to storage devices based on the example estimated read wait times of FIG. 2A.

FIG. 3A illustrates additional example estimated read wait times sorted into an example set of bins.

FIG. 3B illustrates an example assignment of bin numbers to storage devices based on the example estimated read wait times of FIG. 3A.

FIG. 4 illustrates a first example process for determining whether to reconstruct or read requested data.

FIG. 5 illustrates a second example process for determining whether to reconstruct or read requested data.

FIG. 6 illustrates a third example process for determining whether to reconstruct or read requested data.

FIG. 7 illustrates a fourth example process for determining whether to reconstruct or read requested data.

FIG. 8 illustrates a fifth example process for determining whether to reconstruct or read requested data.

FIG. 9 illustrates a non-transitory machine readable medium comprising processor executable instructions including RAID instructions.

### DETAILED DESCRIPTION

### 1—Redundant Array of Independent Disks

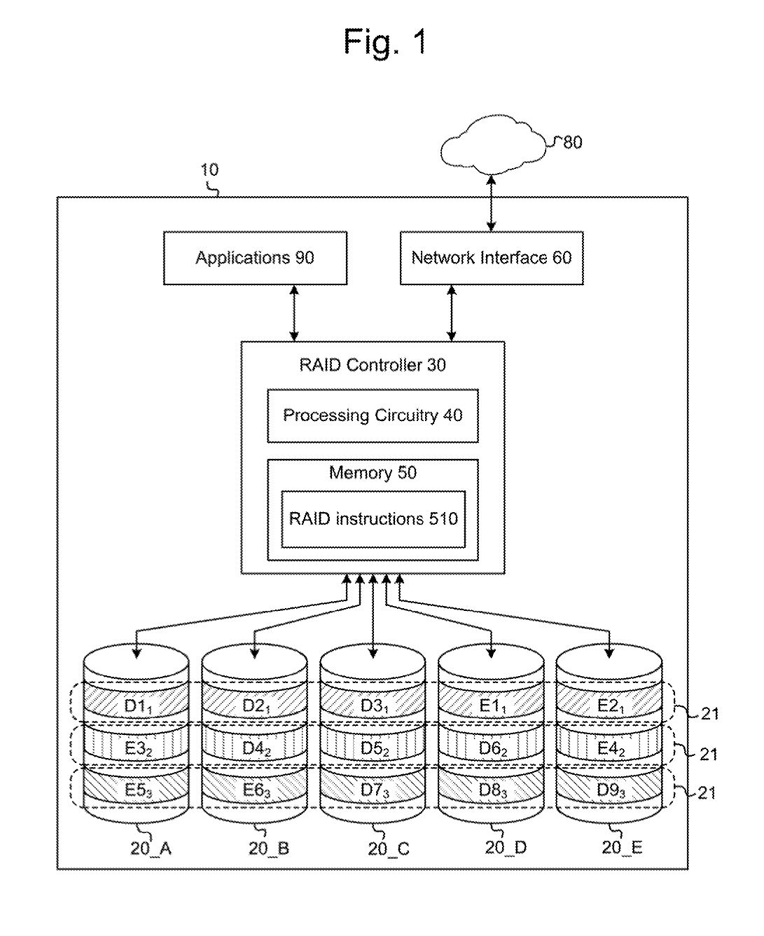

Redundant array of independent disks (RAID) is one class of techniques for protecting data. In RAID techniques, error correction information is generated for a group of data chunks, where the error correction information may be used in combination with a subset of the group of data chunks to reconstruct another data chunk from the group of data chunks. The error correction information may be generated by applying one or more functions or algorithms to the group of data chunks, with the output of each of these functions being one piece of the error correction information. The group of data chunks together with its associated error correction information are referred to collectively as a “stripe”, and these may be distributed (aka “striped”) across multiple storage devices. For example, see FIG. 1, in which data chunks D1-D9 and error correction information E1-E6 are distributed across the storage devices 20 in stripes 21. In the example illustrated in FIG. 1, data chunks and error correction information from the same stripe are illustrated as having the same type of hashing.

Because the data chunks are striped across multiple storage devices and because any data chunk of the stripe may be reconstructed using a subset of the other data chunks of the same stripe, the failure of any one storage device in the system does not result in permanent loss of the data stored on the device. In particular, should one of the storage devices fail, a piece of lost data on the failed device may be reconstructed from the remaining portions of the same stripe as the lost data.

Example RAID techniques may vary from one another in the size of the data chunks included in a stripe (e.g., byte level striping, block level striping, etc.), in the number of pieces of error correction information included in each stripe, and in the function or algorithm used to generate the error correction information from the data chunks (e.g., XOR function, Reed-Solomon coding algorithm, etc.). The example processes described herein are compatible with RAID techniques using any size of data chunks, any number of pieces of error correction information per stripe, and any function(s) to generate error correction information.

RAID may be implemented by a RAID controller and a collection of storage devices. As used herein, a “RAID controller” may be a processor executing software instructions (sometimes referred to as software RAID), dedicated hardware (sometimes referred to as hardware RAID), or any combination of these. The RAID controller implements a RAID volume on the storage devices. The RAID volume is a logical (aka virtual) storage volume that may be presented to clients as a single storage volume that the clients may write data to and read data from.

The RAID controller receives write requests that are directed to the RAID volume, generates error correction information for the data to be written, and writes a stripe to the storage devices by sending individual data chunks to individual storage devices. The RAID controller may also receive read requests that are directed to the RAID volume and retrieve the requested data from the storage devices. The RAID controller may also reconstruct data from a failed storage device by reading individual data chunks (including error correction information) from the same stripe as the piece of data that is to be reconstructed and applying a reconstruction algorithm to the read data chunks.

One way in which a RAID controller may process a read request is to read the requested data directly from the storages device that stores the requested data (the “target device”). In particular, when a RAID controller receives a read request, it may determine which one of the storage devices is the target device, read the requested data from the target device, and return the requested data to the client that requested it. In addition, some RAID controllers may also be able to process a read request by reconstructing the requested data rather than reading it from the target device. This reconstructing of the requested data differs from the reconstruction mentioned above in that it is being done to service an I/O request directed to a target device that is not necessarily in a failed state, but otherwise the mechanics of the reconstruction may be the same (e.g., read data and error correction information from the same stripe as the requested data and apply a reconstruction function to it). One reason that you might chose to reconstruct data even when the target device has not failed is that in some circumstances reconstructing the requested data can be faster than reading the data from the target device.

### 2—Example Technologies for Determining Whether to Read or Reconstruct Requested Data

As noted above, it may be desirable to reconstruct requested data rather than reading the requested data in certain circumstances. However actually identifying in practice when it would be better to reconstruct the requested data instead of reading from the target device can be complicated and difficult to implement. In particular, it is not straightforward what metrics could be used to adequately estimate how long it would take to reconstruct versus read requested data, and many previously proposed metrics fail to adequately reflect the reconstruction and reading times in certain scenarios. Furthermore, whether reconstruction would be better than reading may depend on considerations besides whether it would be faster to read or reconstruct requested data. For example, reconstructing data incurs more processing overhead than reading the data, and this may present a reason, in some instances, to not reconstruct requested data even when it would be faster to do so. As another example, reconstructing one data chunk results in backend read requests to multiple storage devices while reading the data chunk from the target device results in a single backend read request, and therefore reconstructing increases the overall I/O load on the backend of the system much more than reading from the target device. In addition, many approaches to determining whether to read or reconstruct data may add a lot of processing overhead for each read request, and thus may be unrealistic in a large and busy storage system that may have frequent read requests.

Accordingly, disclosed herein are example technologies for determining whether to reconstruct requested data or read the requested data from the target device, which account for the complications noted above and overcome and/or mitigate the difficulties noted above. The example technologies include example processes for determining whether to reconstruct requested data or read the requested data from the target device that may be performed by an example RAID controller of an example storage system, example processor executable instructions that may form part of such an example RAID controller, and example storage systems that may comprise such an example RAID controller.

### 2.1 Example RAID Controller: Overview

In particular, an example RAID controller may determine an estimated read wait time (hereinafter “read metric”) for each of the storage devices. The read metric estimates how long it would take a storage device to process a new read request based on its historic performance (e.g., aggregate per-I/O processing time) and current load (e.g., queue depth). The example RAID controller may sort the read metrics into bins and assign each storage device a bin number based on the bin to which its read metric is sorted. Because the bin number of a storage device depends on its read metric, the bin number of a storage device may be treated as a proxy for how long it would take that storage device to process a new read request.

The example RAID controller may then determine whether to read the requested data from the target device or reconstruct the requested data based on the bin numbers. For example, the RAID controller may make the determination based on based how many of the bin numbers of the non-target storage devices are greater than or greater-than-or-equal-to the difference Δ_{targ-λ} between a bin number of the target storage device and a specified threshold (“λ”). In other words, the determination may be based on how many of the non-target storage devices are assigned to a threshold bin or any higher bin, where the threshold bin is λ lower than the bin of the target device (i.e., the bin number of the threshold bin is equal to Δ_{targ-λ}). In particular, if n or more bin numbers of non-target devices are greater (or equal-to-or-greater) than Δ_{targ-λ}, then the RAID controller may read the requested data from the target device, while if n−1 or fewer bin numbers of the non-target devices are less (or equal-to-or-less) than Δ_{targ-λ}, then the RAID controller may reconstruct the requested data rather than reading it from the target device.

As noted above, the determination is based on how many non-target storage devices have a bin number higher than the difference Δ_{targ-λ} between the bin number of the target device and the threshold λ. One reason for including the threshold λ in the consideration (as opposed to considering just the bin number of the target device) is that small speed improvements resulting from reconstructing rather than reading may not be worth the drawbacks that may be associated with reconstructing the data (such as increased processing overhead). Thus, the specified threshold λ may be set so as to ensure that the time savings (if any) that might result from reconstruction are worth the drawbacks of reconstruction (such as increased processing overhead). In other words, the specified threshold λ reflects a minimum time savings that would be needed to justify reconstructing. In some examples, the specified threshold λ may be an adjustable parameter, which may allow users of the RAID controller to balance time saved versus the other drawbacks of reconstruction according to their own context and hierarchy of values.

By basing the read/reconstruct determination on how many of the non-target devices are assigned bin numbers that are greater than (or greater-than-or-equal-to) Δ_{targ-λ}, it can be ensured that the reconstruction is performed only when it will save a sufficient amount of time to justify the reconstruction. In particular, the total time needed for the reconstruction is controlled by the longest read time out of all of the non-target storage devices that are used in the reconstruction (plus a more-or-less fixed amount of time for processing the reconstruction data after reading it). Because the estimated read times of the devices are reflected by their bin numbers, the estimated total time it would take to perform the reconstruction corresponds to the highest bin number of the non-target devices that are used in the reconstruction. Accordingly, the total savings in time resulting from reconstructing rather than reading corresponds to the difference between the bin number of the target device and the highest bin number of the non-target devices that are used in the reconstruction. Thus, if any storage device whose bin number is greater than (or greater-than-or-equal-to) Δ_{targ-λ} is included in the reconstruction, then the total time savings resulting from reconstructing will necessarily be less than λ, meaning that the total savings is too low to justify the reconstruction. Therefore, the reconstruction is only justified if all of the non-target storage devices that participate in the reconstruction have bin numbers lower than (or lower than-or-equal-to) Δ_{targ-λ}. Because up to n−1 non-target storage devices can be omitted from the reconstruction, this means that the reconstruction can still be justified if n−1 or less of the bin numbers are greater than (or greater-than-or-equal-to) Δ_{targ-λ}, since the non-target devices having bin numbers greater than (or greater-than-or-equal-to) Δ_{targ-λ} may be omitted. However, if n or more non-target storage devices have bin numbers greater than (or greater-than-or-equal-to) Δ_{targ-λ}, because at most n−1 of these may be omitted, at least one of these devices has to take part in the reconstruction, which means the reconstruction would take too long to be justified.

When one of the non-target storage devices is to be omitted from the reconstruction of the requested data, this is referred to hereinafter as “skipping” the storage device. In some examples, all of the non-target storage devices whose bin numbers are greater than (or greater-than-or-equal-to) Δ_{targ-λ} may be skipped. If the fault tolerance of the system is n, then at most n−1 non-target devices may be skipped, since at most n storage device may be omitted from the reconstruction and the target device is always one of the storage devices that is to be omitted from the reconstruction.

There are various ways in which the RAID controller may determine how many bin numbers of non-target devices are greater than Δ_{targ-λ}. For example, in a first approach, cumulative bin amounts may be determined for each bin of the set of bins. In some examples, each cumulative bin amount indicates how many storage devices have been assigned to the corresponding bin or any higher bin (i.e., how many storage devices have been assigned bin numbers that are greater-than-or-equal-to the bin number of the corresponding bin) (hereinafter “upward looking cumulative bin amounts”). In other examples, each cumulative bin amount indicates how many storage devices have been assigned to the corresponding bin or any lower bin (i.e., how many storage devices have been assigned bin numbers that are less-than-or-equal-to the bin number of the corresponding bin) (hereinafter “downward looking cumulative bin amounts”). In the first approach, the number of bin numbers of non-target devices that are greater than Δ_{targ-λ} may be determined by considering the cumulative bin amount of the threshold bin (the threshold bin having the bin number equal to Δ_{targ-λ}).

As another example, in a second approach the number of bin numbers of non-target devices that are greater than Δ_{targ-λ} may be determined by comparing the specified threshold λ to the difference between the bin number of the target device and one or more bin numbers of the non-target devices. For example, if the difference between the target device's bin number and the n^{th} highest bin number of the non-target devices is less than λ, then the RAID controller may know that at least n bin numbers of non-target devices are greater than Δ_{targ-λ}. Conversely, if the difference between the target device's bin number and the n^{th} highest bin number of the non-target devices is greater than λ, then the RAID controller may know that at most n−1 bin numbers of non-target devices are greater than Δ_{targ-λ}. Because the total time needed for the reconstruction to be completed is controlled by the “worst” of the non-skipped non-target devices (i.e., the device with the highest non-skipped bin number), there is no need for the RAID controller to calculate differences between the target bin number and any of the bin numbers of that are less than Δ_{targ-λ}. In other words, the RAID controller may be able to decide whether reconstruction should be carried out based on just a few mathematical operations, such as, in some examples, a single comparison of the cumulative bin amount of the threshold bin

### 2.2—Example Benefits of the Example Technologies

Example processes described herein may solve or mitigate some or all of the difficulties noted above that arise in identifying whether to read requested data and when to reconstruct it. In addition, example processes described herein may account for the complications inherent in identifying whether to read requested data or reconstruct it that may be ignored by other approaches.

For example, as noted above, it is not straightforward what metrics could be used to adequately estimate how long it would take to reconstruct or read requested data, and many previously proposed metrics (such as how busy the storage devices are) fail to reflect the actual reconstruction and reading times in certain scenarios. However, in examples described herein, the read metric is used, which adequately reflects how long reconstruction or reading would take. In particular, the read metric is designed to estimate how long a new read would take to be processed, based on both the historic performance of the storage device is (e.g., aggregate per-I/O processing time) and how busy the device is (e.g., queue depth). Metrics that measure only the performance of the storage device are inadequate, as even a fast storage device may not be able to process a read request quickly under some circumstances. Similarly, metrics that measure only how loaded the storage device is are inadequate, as even a lightly loaded storage device may not be able to process a read request quickly under some circumstances.

As another example benefit, in examples described herein, the determination of whether to reconstruct or read is not necessarily based solely on which would be faster, and other considerations are factored into the determination. In particular, the specified threshold λ may be used to account for such other considerations, such as the processing overhead and backend congestion associated with reconstructions. In addition, in examples in which the specified threshold λ is a parameter that can be set by a user, the user may decide for themselves how important the processing overhead and backend congestion associated with reconstructions are and set the specified threshold λ accordingly.

As another example benefit, in the example processes described herein there may be relatively little processing overhead resulting from the determination of whether to reconstruct or read. In particular, in many approaches the processing overhead associated with determining whether to read or reconstruct can be high. For example, some approaches may make pairwise calculations/comparisons of metrics of all of the storage devices for each read request, resulting in some cases in N*(N−1) metric calculations/comparisons per read request, where N is the total number of storage devices. In contrast, in some examples described herein the determination may require just the bin-sorting operation and a comparison of the cumulative bin amount of the threshold bin to the fault tolerance n, which is much less computationally expensive than many alternative approaches. In particular, the binning of the metrics and calculating the cumulative bin amounts for the bins is a relatively computationally efficient processes. When N is large and read requests occur frequently, this reduction in the number of calculations/comparisons can save substantial processing overhead and make a noticeable difference in the performance of the storage system.

### 3—Example Storage System

### 3.1—Structure

FIG. 1 illustrates an example storage system 10. The example storage system 10 includes multiple storage devices 20, and a RAID controller 30. In some examples, the storage system 10 may also include a network interface 60 and application 90.

The storage devices 20 are any electronic devices that are capable of storing digital data, such as hard disk drives, flash drives, non-volatile memory (NVM), etc. The storage devices 20 do not need to all be the same type of device or have the same capacity. The number of storage devices 20 is not limited in the example storage system 10, apart from whatever requirements may be imposed by the type of RAID the storage system 10 uses. The storage devices 20 are all part of the same RAID group, meaning that data and/or error correction information for a same RAID volume is stored in each of the storage devices 20. In some examples, the storage system 10 may include additional storage devices (not illustrated) beyond the storage devices 20, which are not part of the same RAID group as the storage devices 20; however, references herein and in the appended claims to “storage devices” generally mean the storage devices 20 that are part of the same RAID group, unless clearly indicated otherwise.

The storage devices 20 are communicably connected to the RAID controller 30, such that the RAID controller may send I/O requests (commands) to the storage devices 20 and the storage devices 20 may return data and other replies to the RAID controller 30. There may be one or more intermediaries (not illustrated) between the RAID controller 30 and the storage media of the storage devices 20, which are intentionally omitted from the Figures for the sake of clarity. For example, the intermediaries may include one or more device drivers, one or more networking devices such as switches and routers, one or more storage controllers, one or more servers, and so on.

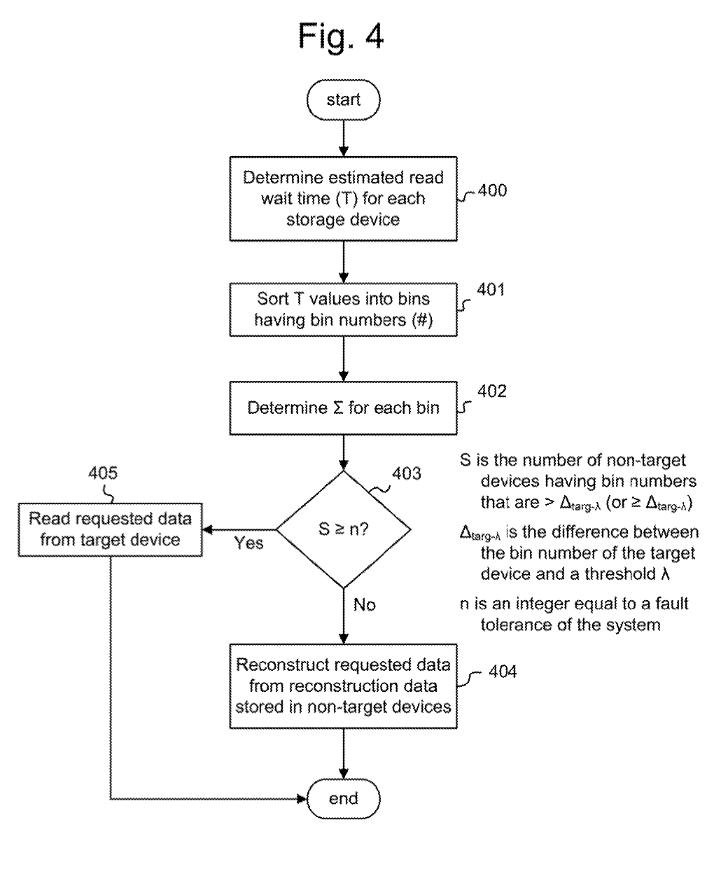

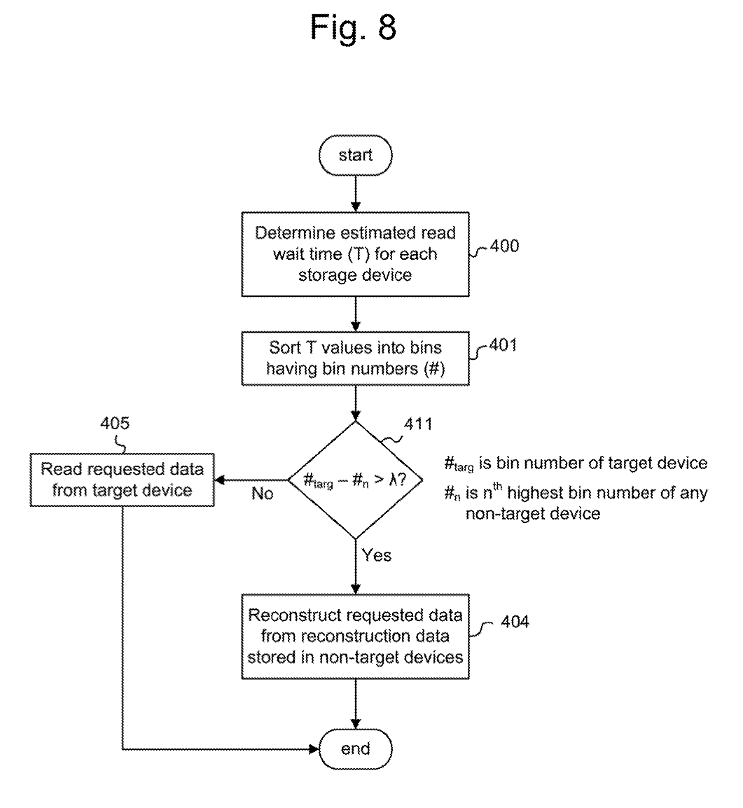

The RAID controller 30 may be formed by processing circuitry 40, and (in some examples) memory 50. The processing circuitry 40 may include a number of processors executing instructions, dedicated hardware, or any combination of these. For example, the RAID controller 30 may be formed (in whole or in part) by a number of processors executing machine-readable instructions that cause the processors to perform operations described herein, such as the operations described in relation to FIGS. 4-8. As another example, the storage controller 30 may be formed (in whole or in part) by a number of processors executing the RAID instructions 510, which are described below in relation to FIG. 8. As used herein, “processor” refers to any circuitry capable of executing machine-readable instructions, such as a central processing unit (CPU), a microprocessor, a microcontroller device, a digital signal processor (DSP), etc. As another example, the RAID controller 30 may be formed (in whole or in part) by dedicated hardware that is designed to perform certain operations described herein, such as any of the operations described in relation to FIGS. 4-8. As used herein, “dedicated hardware” may include application-specific integrated circuits (ASICs), complex programmable logic devices (CPLDs), field-programmable gate arrays (FPGAs), application-specific instruction set processors (ASIP), etc.

In examples in which the RAID controller 30 includes processors that are to execute machine-readable instructions, RAID controller 30 may include memory 50 and the machine-readable instructions (such as the RAID instructions 510) may be stored in the memory 50. The memory 50 may be any non-transitory machine readable medium, which may include volatile storage media (e.g., DRAM, SRAM, etc.) and/or non-volatile storage media (e.g., PROM, EPROM, EEPROM, NVRAM, flash, hard drives, optical disks, etc.).

In examples in which the storage system 10 includes a network interface 60, the network interface 60 may be connected to the RAID controller 30 and to an external network 80 (such as the Internet, a wide-area-network, etc.). In such examples, a client may send I/O requests to the RAID controller 30 and the RAID controller 30 may reply via the external network 80 and the network interface 60.

In examples in which the storage system 10 includes one or more applications 90, any of the applications 90 may send I/O requests to the RAID controller 30. The applications 90 may be formed by a number of processors executing instructions. In some examples, a processor that forms part of the RAID controller 30 may also form part of one of the applications 90; in other words, in such examples the processor that is executing instructions associated with the RAID controller 30 may also be executing instructions associated with one of the applications 90.

In some examples, all of the components of the storage system 10 are part of a single device (i.e., housed within the same chassis), such as a server, personal computer, storage appliance, converged (or hypercongerved) appliance, etc. In other examples, some of the components of the storage system 10 may be part of the same integrated device, while other components may be part of different devices—for example, the storage devices 20 may be external to the device that houses the RAID controller 30.

The RAID controller 30 may be configured to implement a RAID volume on the storage devices 20. Implementing a RAID volume means presenting a logical storage volume to clients (such as the applications 90 or remote clients connecting through the network interface 60) and storing the data written by clients to the volume according to RAID techniques. In particular, implementing a RAID volume includes generating error correction information for data written to the volume, and distributing (striping) the data and error correction information across the storage devices 20. For example, in FIG. 1 the RAID controller 30 is implementing a RAID volume on the storage devices 20. In the example of FIG. 1, data comprising the data chunks D1-D9 was written to the RAID volume, and in response the RAID controller 30 generated error correction information E1-E6, and distributed this along with the data chunks D1-D9 across the storage devices 20 in stripes 21. In the example illustrated in FIG. 1, data chunks and error correction information from the same stripe 21 are illustrated as having the same hashing, and the stripe 21 of a data chunk or error correction information is also indicated in the Figure by a sub-script. The number of data chunks per stripe 21 may be two or more, and the number of pieces of error correction information may be one or more, depending on the RAID technique being implemented. The storage devices 20 that store data from the same RAID volume may be referred to as a “RAID group.”

The RAID controller 30 may, in some examples, implement more than one RAID volume. For example, the RAID controller 30 may implement another RAID volume on storage devices (not illustrated) other than the storage devices 20 (or on the storage devices 20). However, for ease of description it is assumed herein that a single RAID volume is being implemented, and all descriptions should be understood in that context. Thus, for example, it should be understood that references herein and in the appended claims to storage devices (such as “each of the storage devices” or “all of the storage devices” or “all of the non-target devices” etc.) are referring only to those storage devices 20 of the RAID group under consideration.

### 3.2—Determination of Read Vs Reconstruct

The RAID controller 30 may also be configured to process read request directed to the RAID volume according to any of the processes described herein. Specifically, the RAID controller 30 may be configured to determine whether to read requested data from a target device (which is one of the storage devices 20) or to reconstruct the requested data.

In particular, the RAID controller 30 may determine a read metric for each of the storage devices 20. As noted above, the read metric estimates how long it would take a storage device 20 to process a new read request based on its historic performance and current load. In particular, the read metric of a storage device 20 may be, for example, the product of an aggregate per-I/O processing time of the storage device 20 and the current queue depth (i.e., how many I/O requests are in a queue of the storage device 20 waiting their turn to be processed). “Aggregate per-I/O processing time” refers to any statistical aggregation—such as the mean, the median, a specified percentile, etc.—of I/O processing times of a storage device 20 over a specified period of time. In some examples, the storage devices 20 may keep track of their aggregate per-I/O processing time and current queue depth, and report these values to the RAID controller 30. In some other examples, the RAID controller 30 may keep track of one or both of the aggregate per-I/O processing time and current queue depth.

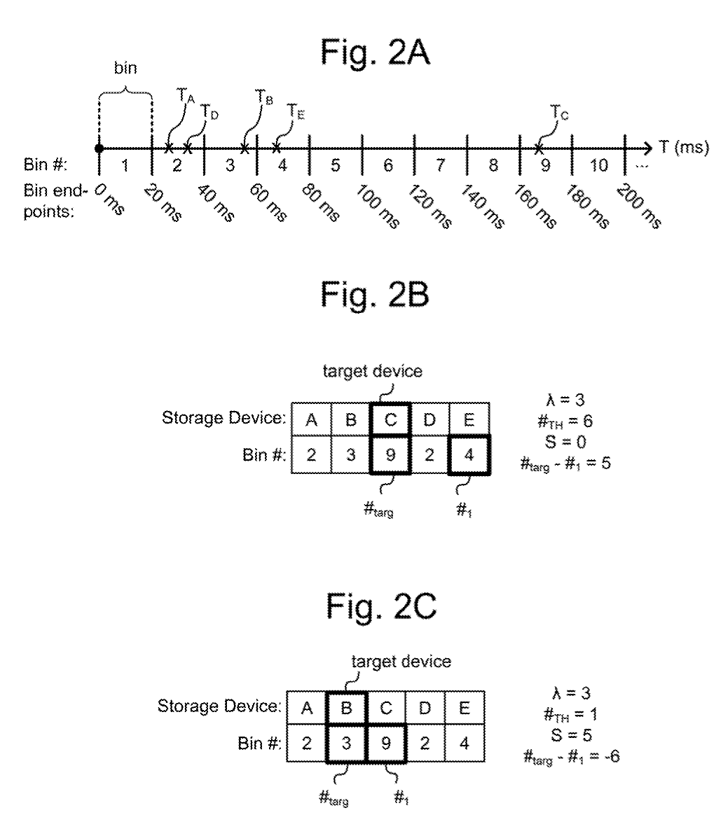

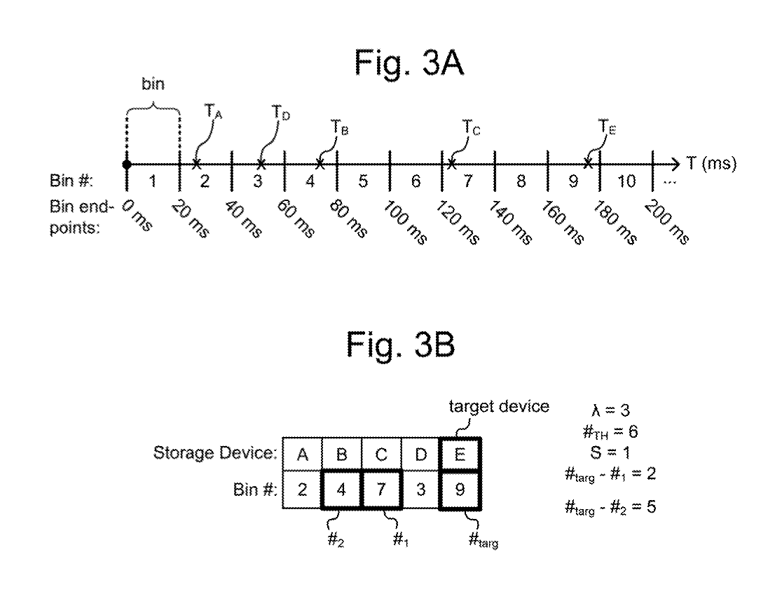

The example RAID controller 30 may sort the read metrics of the storage device 20 into bins (aka buckets) of a specified set of bins. A bin is continuous range or interval of values defined by two endpoints. The specified set of bins may include a contiguous set of bins such that a high endpoint of one bin is a low endpoint of a next bin. For example, FIGS. 2A and 3A illustrate example bins having bin numbers 1-10, as well as read metrics T_{A}-T_{E} sorted into the bins, where the subscripts A-E identify the storage device 20_A-20_E associated with the read metric. In FIGS. 2A and 3A, the bins have uniform widths, but this is merely an example, and some or all of the bins may have non-uniform widths. In FIGS. 2A and 3A, the width of the bins is 20 ms, but this is merely one example, and any bin width may be used. Having wider bins may reduce processing overhead, while having narrower bins may provide more granularity and thus make the bin number a more accurate proxy of read time. In some examples, the bin width may be a parameter that may be adjusted, for example by a user (e.g., client, administrator, etc.) of the storage system 10. Because each endpoint of the set of bins may be an end point of two bins, an end point may be open as to one bin (a value landing on the endpoint is not sorted into the bin) and closed as to another bin (a value landing on the end point is sorted into the bin). Thus, for example, the lower endpoint of each bin may be open as to that bin, while the upper endpoint of each bin may be closed as to that bin, or vice versa.

The example RAID controller 30 may assign each storage device 20 a bin number based on the bin to which its read metric T is sorted. For example, FIGS. 2B and 2C illustrate assignments of bin numbers to storage devices 20 based on the bins to which their respective read metrics are sorted in FIG. 2A, with the storage devices 20_A through 20_E being identified by the letters A-E. Figs. Similarly, FIG. 3B illustrates assignments of bin numbers to storage devices 20 based on the bins to which their respective read metrics are sorted in FIG. 3A. In the examples of FIGS. 2B, 2C, and 3B, the bin number assigned to each storage device 20 is the same as the bin number of its read metric, but it is also possible for the bin number assigned to the storage device 20 to be different from (although based upon) the bin number of its read metric (for example, a specified amount may be added to the bin number of each read metric). Because the bin number of a storage device 20 depends on its read metric, the bin number of a storage device 20 may be treated as a proxy for how long it would take that storage device 20 to process a new read request.

In some examples, the RAID controller 30 may also determine a cumulative bin amount Σ for each of the bins. The cumulative bin amount Σ may be upward looking (Σ⁺) in some examples or downward looking (Σ⁻) in other examples. When the cumulative bin amount Σ⁺ is upward looking, it is equal to the total number of storage devices assigned to the corresponding bin or any higher bin. For example, in FIG. 2A-B the upward looking cumulative bin amount Σ⁺ of bin #4 would be 2, since two storage devices (20_E and 20_C) are assigned to bin #4 or higher. When the cumulative bin amount Σ⁻ is downward looking, it is equal to the total number of storage devices assigned to the corresponding bin or any lower bin. For example, in FIG. 2A-B the downward looking cumulative bin amount Σ⁻ of bin #4 would be 4, since four storage devices (20_A, 20_B, 20_D, and 20_E) are assigned to bin #4 or lower.

In some examples, the RAID controller 30 may determine the read metrics, sort them into bins, and assign bin numbers to the storage devices 20 in response to every read request directed to the RAID volume. In other examples, the RAID controller 30 may determine the read metrics, sort them into bins, and assign bin numbers to the storage devices 20 less frequently than every read request—for example, this may be done periodically at specified intervals.

The RAID controller 30 may, in response to a read request and after the storage devices 20 have been assigned bin numbers, determine whether to read the requested data or reconstruct the data based on the assigned bin numbers. In particular, the RAID controller 30 may make the determination based on based how many (“S”) of the bin numbers of the non-target storage devices are greater than (or greater-than-or-equal-to) the difference Δ_{targ-λ} between a bin number of the target storage device and the specified threshold (“Δ”). In other words, the determination may be based on how many of the non-target storage devices are assigned to any bin higher than a threshold bin (or the threshold bin plus any higher bin), where the threshold bin has a bin number equal to Δ_{targ-λ} (or one if Δ_{targ-λ}<1). In particular, if n or more bin numbers of non-target devices are higher than Δ_{targ-λ} (i.e., if S≥n), then the RAID controller 30 reads the requested data from the target device, while if n−1 or fewer bin numbers of the non-target devices are lower than Δ_{targ-λ} (i.e., if S<n) then the RAID controller 30 may reconstruct the requested data rather than reading it from the target device.

Throughout the disclosure, references are made to the number S of non-target devices having bin numbers that are “greater than” or “greater-than-or-equal-to” Δ_{targ-λ}. It should be understood that such references mean that in some examples, the comparison is “greater than”, while in other examples the comparison is “greater-than-or-equal-to”. Which of the two types of comparisons is used may be arbitrarily selected, as they can be made logically equivalent by appropriately setting λ. In particular, X>Y is logically equivalent to X≥Y+1, where X and Y are integers. Therefore, in examples in which S is equal to the number of non-target devices having a bin number that is greater-than-or equal-to Δ_{targ-λ}, the value of λ may be one bin higher than in other examples in which S is equal to the number of non-target devices having a bin number that is greater than Δ_{targ-λ}.

There are various ways in which the RAID controller may determine S, a few of which will be described below.

### 3.2.1—First Approach: Cumulative Bin Amounts

For example, in a first approach, the cumulative bin amounts Σ may be determined for each bin of the set of bins, and S may be determined by considering the cumulative bin amount of a threshold bin (Σ_{TH}), which is the bin having the bin number equal to Δ_{targ-λ} (or equal to one if Δ_{targ-λ}<1).

For example, if the upward facing cumulative bin amounts Σ⁺ are used, then the number S is equal to Σ⁺_{TH}−1 (the minus one is included because the target device is counted in Σ⁺_{TH}, but it is not a non-target device). Thus, considering the scenario illustrated in FIGS. 2A-B and assuming that λ=3, the threshold bin would be bin #6 and the cumulative bin amount Σ⁺ of this bin is one, and therefore the total number of non-target bin numbers that are greater than Δ_{targ-λ} is zero (i.e., S=Σ⁺_{TH}−1=1−1=0). In this scenario, reconstruction would be selected since no bin numbers of the non-target devices are greater than Δ_{targ-λ} (i.e., S=0). In contrast, considering the scenario illustrated in FIGS. 2A and 2C and assuming that λ=3, the threshold bin would be bin #1 and the cumulative bin amount Σ⁺ of this bin is five, and therefore the total number of non-target bin numbers that are greater than Δ_{targ-λ} is four (S=Σ⁺_{TH}−1=5−1=4). In this scenario, reading from the target device would be selected (unless the fault tolerance of the system were 5 or higher) since S=4.

As another example, if the downward facing cumulative bin amounts Σ⁻ are used, then S is equal to N−Σ⁻_{TH}−1, where N is the total number of storage devices 20. Thus, considering the scenario illustrated in FIGS. 2A-B and assuming that λ=3, the threshold bin would be bin #6 and the cumulative bin amount Σ⁻_{TH} of this bin is four, and therefore the total number of non-target bin numbers that are greater than Δ_{targ-λ} is zero (S=N−Σ⁻_{TH}−1=5−4−1=0). In this scenario, reconstruction would be selected since no bin numbers of the non-target devices are greater than Δ_{targ-λ}. In contrast, considering the scenario illustrated in FIGS. 2A and 2C and assuming that λ=3, the threshold bin would be bin #1 and the cumulative bin amount Σ⁻_{TH} of this bin is zero, and therefore the total number of non-target bin numbers that are greater than Δ_{targ-λ} is four (S=N−Σ⁻_{TH}−1=5−0−1=4). In this scenario, reading from the target device would be selected unless the fault tolerance of the system were 5 or higher since S=4.

As can be seen from the examples above, either one of the upward facing and the downward facing cumulative bin amounts can be used to obtain the same results.

In the description above, it is assumed for simplicity that the cumulative bin amounts Σ include the bin count of the corresponding bin in addition to the bin counts of higher or lower bins. This corresponds to the examples noted above in which S indicates the number of non-target devices having bin numbers that are “greater-than-or-equal-to” Δ_{targ-λ}. However, it is also possible for the cumulative bin amounts to indicate just the bin counts of higher or lower bins, without including the bin count of the corresponding bin. This would correspond to the examples noted above in which S indicates the number of non-target devices having bin numbers that are “greater than” Δ_{targ-λ}.

### 3.2.2—Second Approach: Bin Difference Calculations

Another way to determine the number S is to compare the specified threshold λ to the difference between the bin number of the target device and one or more bin numbers of the non-target devices. For example, the RAID controller 30 may calculate the difference Δbin between the bin number of the target device and at least one of the n highest bin numbers of the non-target devices, and compare the difference(s) Δbin to the specified threshold λ. In particular, if the difference Δbinᵢ=#_{targ}−#ᵢ is less than λ (where #_{targ} is the bin number of the target device and #ᵢ is the i^{th} highest of the non-target devices), then the RAID controller may know that at least i bin numbers of non-target devices are greater than Δ_{arg-λ}, where i is an index indicating a rank ordering of the bin number (e.g., i=1 corresponds to the highest bin number of the non-target devices. i=2 corresponds to the second highest bin number of the non-target devices, etc.). Conversely, if the difference Δbinᵢ is greater than λ, then the RAID controller may know that at most i−1 bin numbers of non-target devices are greater than Δ_{targ-λ}. Therefore, if any of the difference(s) Δbinᵢ for i={0, . . . , n} exceeds the specified threshold λ, then the RAID controller may reconstruct the requested data rather than read from the target device, while if all of the difference(s) Δbinᵢ for i={0, . . . , n} are less than the specified threshold λ, then the example RAID controller may read the requested data from the target device.

Note that the designations “target device” and “non-target device” are specific to a read request, and thus a storage device 20 may be a target device as to one read request and a non-target device as to another read request. Note also that it is possible for the bin number of the target device to be equal to the bin number of one or more non-target devices.

In examples in which the second approach is used, which one(s) of the n highest bin-numbers of the non-target devices that the RAID controller 30 uses in calculating the differences Δbin may depend on the fault tolerance of the system 10 (represented herein by “n”). A first example in which the fault tolerance of the system is n=1 will be described below with reference to FIGS. 2A-2C. Next, a second example in which the fault tolerance of the system is n>1 will be described with reference to FIGS. 3A-3B. The fault tolerance of the storage system 10 is the maximum number of storage devices 20 that can be concurrently failed without suffering permanent data loss of the failed storage device 20. In many examples, the fault tolerance of the storage system 10 is equal to the number of pieces of error correction information that are included per stripe 21.

### 3.2.2.1—Second Approach: First Example, Fault Tolerance Equals One

FIGS. 2B and 2C illustrate examples in which the fault tolerance of the storage system 10 is one. In such examples, the RAID controller 30 may identify the bin number of the target device (#_{targ}), the target device being the one of the storage devices 20 that stores the requested data. The RAID controller 30 may also identify the highest bin-number of any of the non-target devices (#₁), where the non-target devices include all of the storage devices 20 in the RAID group except for the target device. The notation #ᵢ is used herein to refer to bin numbers of the non-target devices, with i indicating the rank ordering of the bin numbers such that #₁≥#₂≥#₃≥ . . . n. The RAID controller 30 may then determine the difference Δbin=#_{targ}−#₁, and compare bin to the specified threshold λ. If Δbin>λ, then the RAID controller 30 determines that it should reconstruct the requested data rather than read it. If Δbin<λ, then the RAID controller 30 determines that it should read the requested data from the target device rather than reconstructing it. The case of Δbin=λ may result in either reconstruction or reading depending on the implementation, or this state may be disallowed (for example, λ may be set to a non-integer value, in which case Δbin, which is always an integer, would never equal λ).

For example, in FIG. 2B, a read request is received by the RAID controller 30 for a chunk of data that is stored in the storage device 20_C. Thus, in this example the target device is the storage device 20_C, and non-target devices are the storage devices 20_A, 20_B, 20_D, and 20_E. Accordingly, as illustrated in FIG. 2B, the bin number of the target device is nine (#_{targ}=9), while the highest bin number of the non-target devices is four (#₁=4). Thus, the difference Δbin is five (Δbin=9−4=5). Assuming that λ=4, then in this case Δbin>λ, and therefore the RAID controller 30 would decide to reconstruct the requested data rather than read it from the target device.

In FIG. 2C, a different read request is received by the RAID controller 30 that requests a chunk of data that is stored in the storage device 20_B. Thus, in this example the target device is the storage device 20_B, and non-target devices are the storage devices 20_A, 20_C, 20_D, and 20_E. Accordingly, as illustrated in FIG. 2C, the bin number of the target device is nine (#_{targ}=3), while the highest bin number of the non-target devices is four (#₁=9). Thus, the difference Δbin is negative six (Δbin=3−9=−6). Assuming that λ=4, then in this case Δbin<λ, and therefore the RAID controller 30 would decide to read the requested data from the target device. As this example illustrates, it is possible for Δbin to be negative.

In these examples, there is no need to perform additional comparisons or calculations besides those noted. In particular, because the fault tolerance in these examples is one, all of the non-target storage devices need to be read from in order to reproduce the requested data. Thus, the slowest of the non-target devices will need to participate in the reconstruction, and will be the limiting factor in how long the reconstruction takes. Thus, the highest bin number #₁ reflects the total time that the reconstruction would take, and the bin numbers of the faster storage devices need not be considered.

### 3.2.2.2—Second Approach: Second Example, Fault Tolerance Two

FIG. 3B illustrates an example in which the fault tolerance of the storage system 10 is two or more. In such examples, the RAID controller 30 may identify the bin number of the target device (#_{targ}). The RAID controller 30 may also identify at least one of the n highest bin-numbers of any of the non-target devices (#₁, #₂, . . . #ₙ) (recall that n is the fault tolerance of the system 10). The RAID controller 30 may then decide to reconstruct the requested data if any of the respective differences between the target bin number #_{targ} and the n highest bin numbers #₁, #₂, . . . #ₙ exceeds the threshold λ. In other words, the RAID controller 30 may reconstruct the requested data if #_{targ}−#ᵢ>λ for any value of i=1, 2, . . . n. Conversely, the RAID controller 30 may decide to read the requested data if all of the respective differences between the target bin number #_{targ} and the n highest bin numbers #₁, #₂, . . . #ₙ are less than the threshold λ. In other words, the RAID controller 30 may read the requested data if #_{targ}−#ᵢ<λ for all values of i=1, 2, . . . n.

In some examples, the RAID controller 30 may determine whether the above-noted conditions are met by iteratively comparing #_{targ}−#ᵢ to λ starting with i=1 until either #_{targ}−#ᵢ>λ or until i=n (hereinafter “the iterative version” of the second approach). In other words, the RAID controller 30 may start with the highest bin number of non-target devices (#₁), and if #_{targ}−#₁>λ then the inquiry may stop there and the RAID controller 30 may decide to reconstruct the requested data without further comparisons. However, if #_{targ}−#₁<λ, then the RAID controller 30 may “skip” #₁ and may then consider the second highest bin number (#₂). This process may be continued, skipping bin numbers and considering the next highest bin number until it is determined that reconstruction should be performed or until the n^{th} highest bin number has been considered, at which point no more bin numbers can be skipped.

For example, consider the scenario illustrated in FIG. 3B assuming that (a) the iterative approach is used, (b) λ=4, and (c) n=2. In such an example, the RAID controller 30 would first compare #_{targ}−#₁ to λ, and determine that #_{targ}−#₁<λ (9−7<4). Because #_{targ}−#₁<λ, the RAID controller 30 would then “skip” #₁, and compare #_{targ} #₂ to λ, and determine that #_{targ}−#₂>λ (9−4>4). Because #_{targ}−#₂>λ, the RAID controller 30 would decide to reconstruct the requested data rather than reading it. If, for the sake of discussion, #_{targ}−#₂ had instead been less than λ, then the RAID controller 30 would not proceed with any more comparisons because the n^{th} bin number had been compared, and thus the RAID controller 30 would decide to read the requested data since #_{targ}−#ᵢ<λ for all i≤n.

In other examples, the RAID controller 30 may jump directly to the n^{th} highest bin number of the non-target device #ₙ rather than working sequentially down from the first highest bin number (hereinafter “the direct version” of the second approach). In such examples, the RAID controller compares #_{targ}−#ₙ to λ, effectively skipping #₁ through #ₙ₋₁ from the start without performing any comparisons using #₁ through #ₙ₋₁. If #_{targ}−#ₙ>λ then the RAID controller 30 may decide to reconstruct the requested data, while if #_{targ}−#₁<λ, then the RAID controller 30 may decide to read the requested data.

For example, consider the scenario illustrated in FIG. 3B assuming that (a) the direct approach is used, (b) Δ=4, and (c) n=2. In such an example, the RAID controller 30 would compare #_{targ}−#₂ to λ (skipping #₁), and determine that #_{targ}−#₂>λ (9−4>4). Because #_{targ}−#₂>λ, the RAID controller 30 would decide to reconstruct the requested data rather than reading it. If, for the sake of discussion, #_{targ}−#₂ had instead been less than λ, then the RAID controller 30 would not proceed with any more comparisons (if #₂ is <λ then #₁<λ is also true by definition, since #₁≥#₂), and thus the RAID controller 30 would decide to read the requested data since #_{targ}−#ᵢ<λ for all i≤n.

The direct approach may sometimes result in fewer (and never results in more) comparisons being performed than in the iterative approach. Thus, in some circumstances the direct approach may reduce the processing overhead associated with determining whether to read or reconstruct. On the other hand, the iterative approach can, in some cases, reduce the processing overhead associated with reconstructing requested data. In particular, for some RAID technologies, the complexity of reconstructing data increases as the number of storage devices that do not participate in the reconstruction increases. For example, in RAID 6 if a single storage device is skipped, then a simple XOR function may be applied to the reconstruction data, but if two storage devices 20 are skipped, then a more complicated algorithm may need to be applied to the reconstruction data. Because the direct approach may skip more (and never skips less) storage devices than the iterative approach, the iterative approach may, in the long run, result in slightly less processing overhead associated with reconstruction. Whether the direct approach or the iterative approach is preferred may depend on the use-case for the storage system 10. In some examples, the RAID controller 30 may be configured to be capable of using both approaches, and a user may select between the approaches based on their context and values.

In examples in which n>1, it may be the case that not all of the non-target storage devices 20 are needed to perform the reconstruction. In such a case, the RAID controller 30 may select which ones of non-target storage devices 20 should be used in the reconstruction based on their bin numbers. For example, the RAID controller 30 may select the storage devices 20 having the lowest bin numbers to read from as part of the reconstruction. As another example, the RAID controller 30 may select any of the storage device 20 that have not been “skipped” in determining whether to reconstruct the storage device. The storage devices 20 that were skipped are not used because their having been skipped means that their estimated read time (as reflected by their bin number) is too high to justify reconstruction.

Throughout the disclosure, references are made to the rank ordering of the bin numbers assigned to the non-target devices, such as referring to the highest bin number, the second highest bin number, the n highest bin numbers, etc. It should be noted that it is possible that more than one storage device 20 may be assigned the same bin number. In cases in which there is a group of identical bin numbers, the identical bin numbers may be considered as having any rank ordering within the group that is consistent with the rank ordering of the group as a whole. For example, if the set {2_{C}, 3_{A}, 6_{B}, 6_{E}} comprises all of the bin numbers that are assigned to the non-target storage devices (with the subscript identifying the associated storage device 20), then 6 is both the highest bin number and the second highest bin number of the non-target devices, and either of the storage devices 20_B and 20_E may be considered as the storage device 20 having the highest bin number. In examples in which multiple bin numbers are identical, if a calculation has been made for one of the bin numbers, then the calculation may be omitted for the second bin number. For example, using the set of bin number {2_{C}, 3_{A}, 6_{B}, 6_{E}} again, if #_{targ}−#₁ has been calculated and compared to λ, there is no need to calculate #_{targ}−#₂ and compare this to λ, since #₁=#₂.

The description herein assumes for the sake of convenience that all of the storage devices 20 of the RAID group are not in a failed state. However, if any of the storage devices 20 are in a failed state, the example processes described herein may take this into account. For example, in examples implementing the first approach, the number of failed devices may be added to each of the upward facing cumulative bin amounts Σ⁺ or subtracted from each of the downward facing cumulative bin amounts Σ⁺. As another example, the failed storage devices 20 may be assigned to a predetermined bin number, such as a highest possible bin number. As another example, the value of “n” may be adjusted from the actual fault tolerance of the system to equal the fault tolerance of the system minus the number of failed storage devices 20. In certain examples, the RAID controller 30 may decide to read the requested data from the target devices if the number of failed storage devices 20 is equal to or greater than the fault tolerance of the system, and may omit performing the process of determining whether to read or reconstruct (since reconstruction would not be possible in such cases).

### 4—Example Processes

FIGS. 4-8 illustrate various example processes/methods. The example processes may be performed, for example, by a RAID controller, such as the RAID controller 30 described above. For example, the example processes may be embodied (in whole or in part) in machine readable instructions that, when executed by a processor of the RAID controller, cause the RAID controller to perform (some or all of) the operations of the example processes. As another example, the example processes may be embodied (in whole or in part) in logic circuits of dedicated hardware of the RAID controller that perform (some or all of) the operations of the example processes.

Some of the operations illustrated in FIGS. 4-8 and described below are performed in more than one (or even all) of the example processes, and such operations are given the same block number in the process flow charts of FIGS. 4-8. Such features are described just once below, to avoid duplicative description.

### 4.1—First Example Process: First Approach (Cumulative Bin Amounts)

FIG. 4 illustrates a first example process. The first example process corresponds to the “first approach” described above in which cumulative bin amounts are used.

In block 400, the RAID controller determines estimated read times (“read metrics”) T for each of the storage devices in the RAID group. This may include obtaining historic performance data (e.g., aggregate per-I/O processing time) and current load data (current queue depth) from the storage devices, and calculating the read metrics from the obtained data (e.g., multiplying the aggregate per-I/O processing time by the current queue depth). Alternatively, the RAID controller may generate the historic performance data and current load data based on its own information, and calculate the read metrics from the generated data. After block 400, the process continues to block 401.

In block 401, the RAID controller sorts the read metrics T into bins of a specified set of bins, and associates bin numbers with the storage devices based on the bins to which their respect read metrics T have been assigned. For example, the storage devices may be associated with the bin numbers of the bins to which their respective read metrics are sorted (e.g., if the read metric of device A is assigned to the 3^{rd} bin, then device A has the bin number 3 associated with it). As another example, the non-target storage devices may be associated with bin numbers that comprise a fixed value plus the respective bin numbers of the bins to which their respective read metrics are sorted (e.g., if the read metric of non-target device A is assigned to the 3^{rd} bin and the fixed value is 1, then device A has the bin number 4 associated with it). After block 401, the process continues to block 403.

In block 402, the RAID controller determines the cumulative bin amounts Σ for each of the bins. These may be upward facing or downward facing as described above.

In block 403, the RAID controller determines whether S (the number of non-target devices having bin numbers greater than (or greater-than-or-equal-to) Δ_{targ-λ}) is greater than or equal to n. This is the equivalent of determining whether the number of non-target devices having bin numbers less than (or less-than-or-equal-to) Δ_{targ-λ} is greater than or equal to N−n. If block 403 is answered No, then the process continues to block 404. If block 403 is answered Yes, then the process continues to block 405.

In block 404, the RAID controller decides to reconstruct the requested data from reconstruction data that is read from the non-target storage devices, rather than reading the requested data from the target device. The process may then end.

In block 405, the RAID controller decides to read the requested data from the target device rather than reconstructing the requested data. The process may then end.

In some examples, blocks 400-405 may all be performed in response to the RAID controller receiving a read request directed at the RAID volume. In other examples, blocks 400-402 may be performed not necessarily in response to a specific read request (e.g., it may be performed periodically at specified intervals), and then blocks 403-405 may be performed subsequently in response to a read request.

### 4.2—Second Example Process: Second Approach, Fault Tolerance Equals One

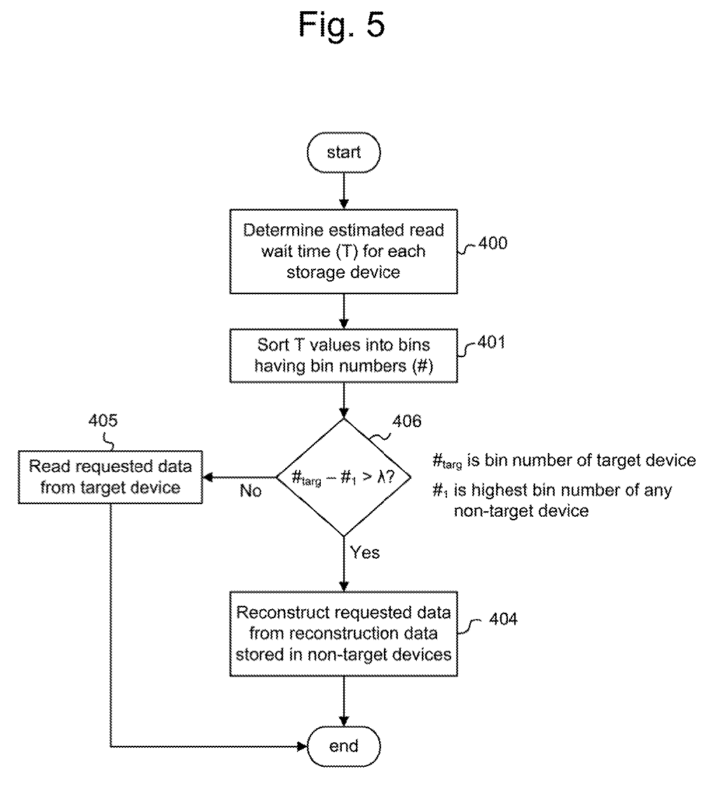

FIG. 5 illustrates a second example process. The second example process corresponds to the “second approach” described above, and may be performed, for example, when the fault tolerance of the storage system is equal to one.

The second example process includes the operations of blocks 400, 401, 404, and 405, which are the same as blocks 400, 401, 404, and 405 in the first example process described above. In particular, the second example process is similar to the first example process, except that block 402 may be omitted and block 406 is substituted for block 403.

In block 406, the RAID controller determines whether the difference between the bin number of the target device (#_{targ}) and the highest bin number of the non-target devices (#ᵢ) is greater than the threshold λ. If #_{targ}−#₁>λ (block 403=Yes), then the process continues to block 404. If #_{targ}−#₁<λ (block 403=No), then the process continues to block 405. Although not illustrated in FIG. 4, the case of #_{targ}−#₁=λ can be dealt with in any way that is desired. For example, #_{targ}−#₁=λ could result in the process continuing to either of block 404 or 405. As another example, #_{targ}−#₁=λ may be a disallowed state (for example, λ may be set to a non-integer value).

### 4.3—Third Example Process: Second Approach, Fault Tolerance Equals Two

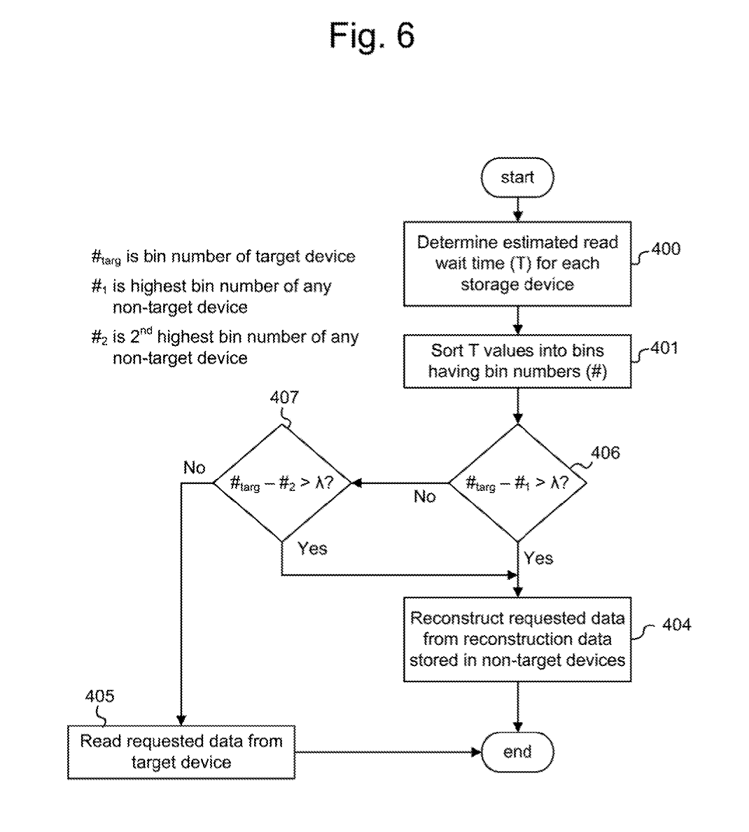

FIG. 6 illustrates a third example process. The third example process corresponds to the “second approach” described above, and may be performed, for example, when the fault tolerance of the storage system is n=2.

The third example process includes the operations of blocks 400, 401, 404, and 405, which are the same as blocks 400, 401, 404, and 405 in the first example process described above. In particular, the third example process is similar to the second example process except that the third example process includes an additional operation in block 407, which is performed on the “No” branch of decision block 406. In particular, at block 406 when #_{targ}−#₁<λ (block 403=No) the second example process continues to block 407 rather than to block 405.

In block 407, the RAID controller determines whether the difference between the bin number of the target device (#_{targ}) and the second highest bin number of the non-target devices (#₂) is greater than the threshold λ. In other words, in block 406 the highest bin number #₁ is skipped, and the next highest bin number is considered. If #_{targ}−#₂>λ (block 406=Yes), then the process continues to block 404. If #_{targ}−#₂<λ (block 406=No), then the process continues to block 405. Although not illustrated in FIG. 5, the cases of #_{targ}−#₁=λ or #_{targ}−#₂=λ can be dealt with in any way that is desired, as described above in relation to the first example process.

Thus, the third example process is similar to the second example process, except that in the third example process the highest bin number #₁ may be skipped if it does not satisfy #_{targ}−#₁<λ.

### 4.3—Fourth Example Process: Second Approach, Iterative Version

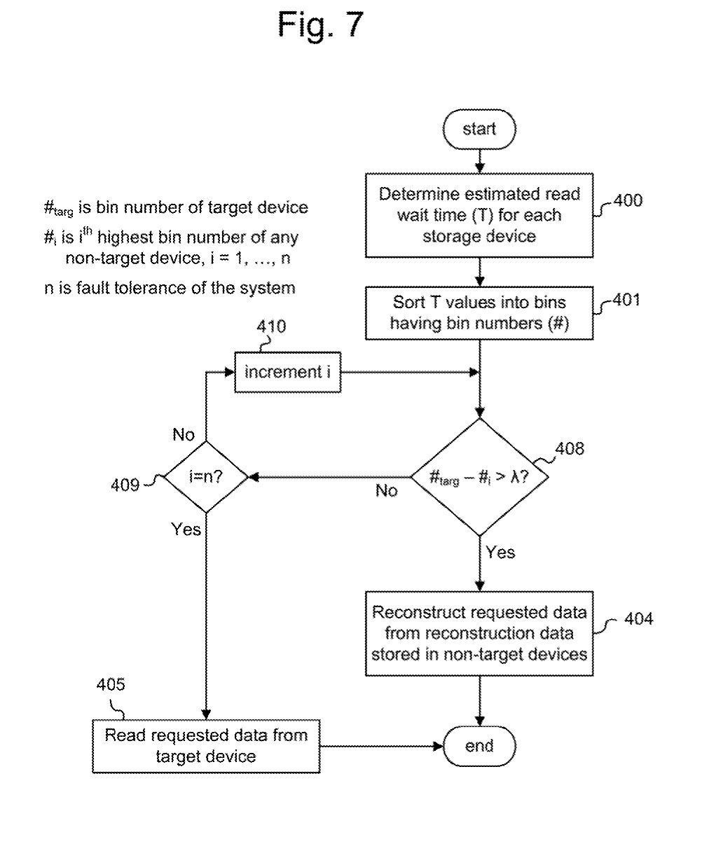

FIG. 7 illustrates a fourth example process. The fourth example process corresponds to the iterative version of the second approach described above. The fourth example process is generalized for any fault tolerance. The fourth example process may be reduced to the second or third example processes (FIGS. 5 and 6) when n=1 or n=2, respectively.

The fourth example process includes the operations of blocks 400, 401, 404, and 405, which are the same as the blocks having the same reference numbers in the example processes described above. However, the fourth example process includes the additional operations in blocks 408, 409, and 410, instead of the blocks 403, 406, 407, or 411. In particular, the fourth example process is similar to the second example process except that in the fourth example process the loop comprising blocks 408-410 is substituted for the block 406. The fourth example process is also similar to the third example process except that in the fourth example process the loop comprising blocks 408-410 is substituted for blocks 406 and 407.

In block 408, the RAID controller determines whether the difference between the bin number of the target device (#_{targ}) and the i^{th} highest bin number of the non-target devices (#ᵢ) is greater than the threshold λ, where i is an index running from 1 to n. The index i may start with 1, meaning that the first difference calculation is performed with the highest bin number of the non-target devices. If #_{targ}−#ᵢ>λ (block 407=Yes), then the process continues to block 404. If #_{targ}−#ᵢ<λ (block 407=No), then the process continues to block 408. Although not illustrated in FIG. 6, the cases of #_{targ}−#ᵢ=λ can be dealt with in any way that is desired, as described above in relation to the first example process.

In block 409, it is determined whether the index i equals the fault tolerance n. If i=n (block 409=Yes), then the process continues to block 405. If i≠n (block 409=No), then the process continues to block 409.

In block 410, the index i is incremented. The process then continues to block 408.

Blocks 408-410 form a loop in which #_{targ}−#ᵢ is iteratively compared to λ, increasing i each iteration, until either: (A) it is determined that #_{targ}−#ᵢ>λ, in which case the requested data is reconstructed (block 404), or (B) it is determined that #_{targ}−#ₙ<λ, in which case the requested data is read from the target device (block 405). Each time block 408 is reached in the loop, the previously considered bin number (#ᵢ₋₁) is skipped, and the next highest bin number (#ᵢ) is considered.

### 4.4—Fifth Example Process: Second Approach, Direct Version

FIG. 8 illustrates a fifth example process. The fifth example process corresponds to the direct version of the second approach described above. The fifth example process is generalized for any fault tolerance. The fifth example process may be reduced to the second example process (FIG. 5) when n=1.

The fifth example process includes the operations of blocks 400, 401, 404, and 405, which are the same as the blocks having the same reference numbers in the example processes described above. However, the fifth example process includes the decision block 411 instead of the blocks 403, or 406-410. In particular, the fifth example process is similar to the second example process except that in the fifth example process the block 411 is substituted for the block 406. In addition, the fifth example process is similar to the third example process except that in the fifth example process the block 411 is substituted for blocks 406 and 407. In addition, the fifth example process is similar to the fourth example process except that in the fifth example process the block 411 is substituted for the loop comprising blocks 408-410.

In block 411, the RAID controller determines whether the difference between the bin number of the target device (#_{targ}) and the n^{th} highest bin number of the non-target devices (#ₙ) is greater than the threshold λ, where n is the fault tolerance of the system. If #_{targ}−#ₙ>λ (block 411=Yes), then the process continues to block 404. If #_{targ}−#ₙ<λ (block 411=No), then the process continues to block 405. Although not illustrated in FIG. 8, the cases of #_{targ}−#ₙ=λ can be dealt with in any way that is desired, as described above in relation to the first example process.

### 5—Example Processor Executable Instructions

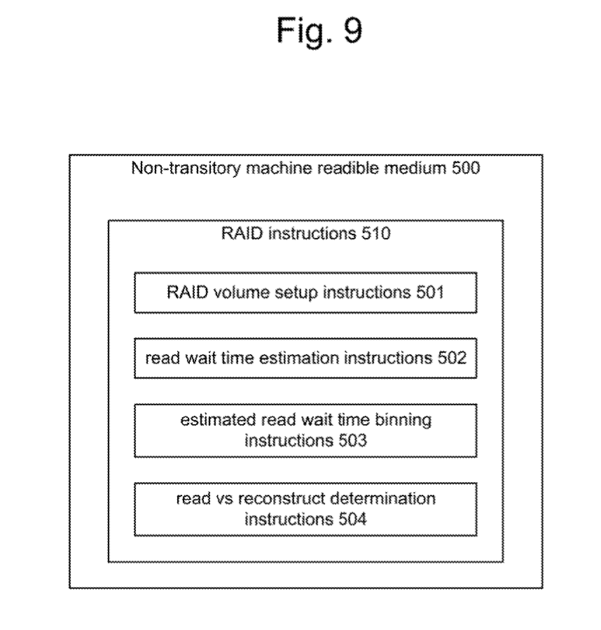

FIG. 9 illustrates example processor executable instructions stored on a non-transitory machine readable medium 500. In particular, RAID instructions 510 are stored on the medium 500.

The RAID instructions 510 may include instructions to perform any or all of the operations described herein, including, for example, any of the example processes illustrated in FIGS. 4-8.

For example, the RAID instructions 510 may include RAID volume setup instructions 501, read wait time estimation instructions 502, estimated read wait time binning instructions 503, and read vs reconstruct determination instructions 504.

The RAID volume setup instructions 501 may include instructions to implement a RAID volume using a number of storage devices. For example, these instructions may be instructions that, when executed by a processor, cause the processor to present a logical storage volume to clients and store data written by clients to the volume according to RAID techniques, as described above.

The read wait time estimation instructions 502 may include instructions to determine an estimated read wait time for each of the storage devices. For example, these instructions may be instructions that, when executed by a processor, cause the processor to obtain or generate historic performance data (e.g., aggregate per-I/O processing time) for each storage device in the RAID group and current load data (e.g., queue depth) for each storage device in the group, and calculate the estimated read wait times based on the historic performance data and the current load data. For example, the instructions may be to multiply aggregate per-I/O processing times by queue depths.

The estimated read wait time binning instructions 503 may include instructions to sort the estimated read wait times into bins of a specified set of bins, and associate bin numbers with the storage devices based on the bins of their respective estimated read wait times.

The read vs reconstruct determination instructions 504 may include instruction to, in response to a read request directed to the RAID volume: compare a specified threshold to the difference between a bin number of the target storage device and a highest bin number of any non-target storage devices of the storage devices, and in response to the difference between the bin number of the target storage device and the highest bin number of any of the non-target storage devices exceeding the specified threshold, reconstruct the requested data from reconstruction data stored in the non-target storage devices rather than reading the requested data from the target storage device. The instructions may also include instructions to read the requested data from the target storage device in response to the difference between the bin number of the target storage device and the highest bin number of any of the non-target storage devices being less than the specified threshold. The instructions may also include instructions to read the requested data from the target storage device in response to respective differences between the bin number of the target device and the n highest bin numbers of the non-target storage devices all being less than the specified threshold, where n is the fault tolerance of the RAID volume and n≥2. The instructions may also include instructions to reconstruct the requested data in response to any one of the respective differences between the bin number of the target device and the n highest bin numbers of the non-target storage devices exceeding the specified threshold, where n is the fault tolerance of the RAID volume and n≥2. The instructions may also include instructions to, in response to deciding to reconstruct the requested data and the fault tolerance of the RAID volume being greater than one, determine which ones of the non-target storage devices to read reconstruction data from based on the respective bin numbers of the non-target storage devices.

As used herein “RAID” refers to any technique in which: (A) data that is written to a logical volume (RAID volume) is broken into chunks, (B) error correction information is generated for a group of data chunks such that any data chunk of the group can be reconstructed using error correction information and a subset of data chunks of the group, and (C) the group of data chunks together with its associated error correction information are distributed (aka “striped”) across multiple storage devices. Certain techniques have been given specific names in common usage that include the term “RAID” (e.g., RAID 0, RAID 1, RAID 5, RAID 6, etc.), but whether or not the common name given to a technique includes the term “RAID” does not affect whether or not it would qualify as a RAID technique as the term is used herein. For example, the techniques commonly referred to as RAID 5 and RAID 6 would be considered RAID techniques as the term is used herein, while RAID 0 and RAID 1 would not qualify as RAID techniques as the term is used herein. As another example, many techniques whose common names do not include the term “RAID” may be nonetheless considered as RAID techniques in this disclosure, such as many so-called Erasure Coding techniques.

As used herein, a “computer” is any electronic system that includes a processor and that is capable of executing machine-readable instructions, including, for example, a server, certain storage arrays, a composable-infrastructure appliance, a converged (or hyperconverged) appliance, a rack-scale system, a personal computer, a laptop computer, a smartphone, a tablet, etc.

As used herein, to “provide” an item means to have possession of and/or control over the item. This may include, for example, forming (or assembling) some or all of the item from its constituent materials and/or, obtaining possession of and/or control over an already-formed item.

Throughout this disclosure and in the appended claims, occasionally reference may be made to “a number” of items. Such references to “a number” mean any integer greater than or equal to one. When “a number” is used in this way, the word describing the item(s) may be written in pluralized form for grammatical consistency, but this does not necessarily mean that multiple items are being referred to. Thus, for example, a phrase such as “a number of active optical devices, wherein the active optical devices . . . ” could encompass both one active optical device and multiple active optical devices, notwithstanding the use of the pluralized form.

The fact that the phrase “a number” may be used in referring to some items should not be interpreted to mean that omission of the phrase “a number” when referring to another item means that the item is necessarily singular or necessarily plural.

In particular, when items are referred to using the articles “a”, “an”, and “the” without any explicit indication of singularity or multiplicity, this should be understood to mean that there is “at least one” of the item, unless explicitly stated otherwise. When these articles are used in this way, the word describing the item(s) may be written in singular form and subsequent references to the item may include the definite pronoun “the” for grammatical consistency, but this does not necessarily mean that only one item is being referred to. Thus, for example, a phrase such as “an optical socket, wherein the optical socket . . . ” could encompass both one optical socket and multiple optical sockets, notwithstanding the use of the singular form and the definite pronoun.

Occasionally the phrase “and/or” is used herein in conjunction with a list of items. This phrase means that any combination of items in the list—from a single item to all of the items and any permutation in between—may be included. Thus, for example, “A, B, and/or C” means “one of: {A}, {B}, {C}, {A, B}, {A, C}, {C, B}, and {A, C, B}”.

Various example processes were described above, with reference to various example flow charts. In the description and in the illustrated flow charts, operations are set forth in a particular order for ease of description. However, it should be understood that some or all of the operations could be performed in different orders than those described and that some or all of the operations could be performed concurrently (i.e., in parallel).

While the above disclosure has been shown and described with reference to the foregoing examples, it should be understood that other forms, details, and implementations may be made without departing from the spirit and scope of this disclosure.

What is claimed is:

1. A data storage system comprising:
a number of storage devices; and
processing circuitry that is to:
implement a redundant array of independent disks (RAID) volume using the storage devices;
determine an estimated read wait time for each of the storage devices;
sort the estimated read wait times into bins of a specified set of bins;
associate bin numbers with the storage devices based on the bins of their respective estimated read wait times;
in response to a read request directed to the RAID volume, determine whether to read requested data specified in the read request from a target storage device, which is one of the storage devices that stores the requested data, or reconstruct the requested data from data stored in non-target storage devices of the storage devices, based on how many of the bin numbers of the non-target storage devices are greater than or greater-than-or-equal-to the difference between a bin number of the target storage device and a specified threshold.

2. The data storage system of claim 1,
wherein the processing circuitry is to decide to reconstruct the requested data in response to none of the bin numbers of the non-target storage devices being greater than or greater-than-or-equal-to the difference between the bin number of the target storage device and the specified threshold.

3. The data storage system of claim 2,
wherein the processing circuitry is to decide to read the requested data from the target storage device in response to a single one of the bin numbers of the non-target storage devices being greater than or greater-than-or-equal-to the difference between the bin number of the target storage device and the specified threshold.

4. The data storage system of claim 1,
wherein the processing circuitry is to decide to reconstruct the requested data in response to n−1 or fewer of the bin numbers of the non-target storage devices being greater than the difference between the bin number of the target storage device and the specified threshold, where n is an integer equal to a fault tolerance of the data storage system.

5. The data storage system of claim 4,
wherein the processing circuitry is to decide to read the requested data from the target storage device in response to n or more of the bin numbers of the non-target storage devices being greater than or greater-than-or-equal-to the difference between the bin number of the target storage device and the specified threshold.

6. The data storage system of claim 4,
wherein the processing circuitry is to, in response to deciding to reconstruct the requested data and the fault tolerance of the RAID volume being greater than one, determining which ones of the non-target storage devices to read reconstruction data from based on the respective bin numbers of the non-target storage devices.

7. The data storage system of claim 1,
wherein the processing circuitry is to:
determine cumulative bin amounts for each bin of the set of bins, each of the cumulative bin amounts indicating how many storage devices have been assigned bin numbers that are either greater-than-or-equal-to or less-than-or-equal-to the bin number of the corresponding bin; and
determine how many of the bin numbers of the non-target storage devices are greater than or greater-than-or-equal-to the difference between the bin number of the target storage device and the specified threshold based on the cumulative bin amount of a threshold bin, wherein the threshold bin is the bin of the set of bins whose bin number is equal to the difference between the bin number of the target storage device and the specified threshold.

8. The data storage system of claim 1,
wherein the processing circuitry is to determine how many of the bin numbers of the non-target storage devices are greater than or greater-than-or-equal-to the difference between the bin number of the target storage device and the specified threshold by comparing the specified threshold to the difference between a bin number of the target storage device and an n^{th} highest bin number of any of the non-target storage devices, where n is an integer equal to a fault tolerance of the data storage system.

9. The data storage system of claim 1,
wherein the processing circuitry is to determine the estimated read wait time for a given storage device of the storage devices by multiplying an aggregate per-I/O processing time of the given storage device by a queue depth of the given storage device.

10. The data storage system of claim 1,
wherein the specified threshold is a parameter that is adjustable by a user of the data storage system.

11. The data storage system of claim 1,
wherein a bin width of the set of bins is a parameter that is adjustable by a user of the data storage system.

12. A non-transitory machine readable medium comprising processor executable instructions including:
instructions to implement a redundant array of independent disks (RAID) volume using a number of storage devices;
instructions to determine an estimated read wait time for each of the storage devices;
instructions to sort the estimated read wait times into bins of a specified set of bins, and associate bin numbers with the storage devices based on the bins of their respective estimated read wait times;
instructions to, in response to a read request directed to the RAID volume, the read request specifying requested data that is stored in a target storage device of the storage devices:
determine how many of the bin numbers of the non-target storage devices are greater than or greater-than-or-equal-to the difference between a bin number of the target storage device and a specified threshold, and
in response to none of the bin numbers of the non-target storage devices being greater than or greater-than-or-equal-to the difference between the bin number of the target storage device and the specified threshold, reconstruct the requested data from reconstruction data stored in the non-target storage devices rather than reading the requested data from the target storage device.

13. The non-transitory machine readable medium of claim 12, the processor executable instructions further including:
instructions to read the requested data from the target storage device in response to a single one of the bin numbers of the non-target storage devices being greater than or greater-than-or-equal-to the difference between the bin number of the target storage device and the specified threshold.

14. The non-transitory machine readable medium of claim 12, the processor executable instructions further including:
instructions to read the requested data from the target storage device in response to n or more of the bin numbers of the non-target storage devices being greater than or greater-than-or-equal-to the difference between the bin number of the target storage device and the specified threshold, where n is an integer equal to a fault tolerance of the data storage system.

15. The non-transitory machine readable medium of claim 12, the processor executable instructions further including:
instructions to reconstruct the requested data in response to n−1 or fewer of the bin numbers of the non-target storage devices being greater than the difference between the bin number of the target storage device and the specified threshold, where n is an integer equal to a fault tolerance of the data storage system.

16. The non-transitory machine readable medium of claim 12, the processor executable instructions further including:
instructions to, in response to deciding to reconstruct the requested data and the fault tolerance of the RAID volume being greater than one, determine which ones of the non-target storage devices to read reconstruction data from based on the respective bin numbers of the non-target storage devices.

17. The non-transitory machine readable medium of claim 12, the processor executable instructions further including:
instructions to determine the estimated read wait time for a given storage device of the storage devices by multiplying an aggregate per-I/O processing time of the given storage device by a queue depth of the given storage device.

18. A data storage system comprising:
a number of storage devices; and
processing circuitry that is to:
implement a RAID volume using the storage devices, the RAID volume having a fault tolerance of n, wherein n≥2;
determine an estimated read wait time for each of the storage devices;
sort the estimated read wait times into bins of a specified set of bins;
associate bin numbers with the storage devices based on the bins of their respective estimated read wait times; and
in response to a read request directed to the RAID volume that specifies requested data that is stored in a target storage device of the storage devices:
read the requested data from the target storage device in response to n or more of the bin numbers of the non-target storage devices being greater than or greater-than-or-equal-to the difference between the bin number of the target storage device and a specified threshold; and
reconstruct the requested data in response to n−1 or fewer of the bin numbers of the non-target storage devices being greater than the difference between the bin number of the target storage device and the specified threshold.

19. The data storage system of claim 18,
wherein the processing circuitry is to determine the estimated read wait time for a given storage device of the storage devices by multiplying an aggregate per-I/O processing time of the given storage device by a queue depth of the given storage device.

20. The data storage system of claim 18,
wherein the specified threshold is a parameter that is adjustable by a user of the data storage system.
